(19) United States
(12) Patent Application Publication
(10) Pub. No.: US 2003/0200145 A1
(43) Pub. Date: Oct. 23, 2003

(54) Internet-based system and method for creating and distributing customized rich media marketing and sales materials via e-mail

(76) Inventors: Brad Krassner, Miami Beach, FL (US); Nikolai Mentchoukov, Scottsdale, AZ (US)

Correspondence Address: GREENBERG TRAURIG, P.A., 1221 Brickell Avenue, Miami, FL, 33131, US

(21) Appl. No.: 10/417,478

(22) Filed: Apr. 17, 2003

Related U.S. Application Data
(60) Provisional application No. 60/373,625, filed on Apr. 18, 2002.

(51) Int. Cl. G06F 17/60

(52) U.S. Cl. 705/14

(57) ABSTRACT

The present invention is a method for business sales personnel to create and send customized rich media marketing and sales materials via e-mail to potential customers, comprising the steps of selecting one or more files containing sales or marketing materials pertaining to said business previously stored in electronic format in a database within a computer server accessible by said business sales personnel for delivery to the intended recipient, creating an e-mail that provides said sales or marketing material files or access to said files in said database within said computer server when said e-mail is opened via a data string representing the contents of said materials with a uniform resource locator forming part of said data string representing a customer server-based application to provide access to said materials, and sending said e-mail to said intended recipient.

The present invention is also a system for use by business sales personnel to create and send to potential customers customized rich media marketing and sales materials via e-mail comprising a system-end computer including an Internet communications server configured to host an Internet access software application program and including an Internet communications interface, a main processing unit and a mass storage device containing one or more databases storing marketing and sales information files pertaining to said business, a system user-end computer configured for Internet access and communicating with said system Internet communications server, an e-mail recipient-end computer configured for Internet access and communicating with said system Internet communications server, interface means for selecting one or more sales or marketing information files from said one or more searchable databases for creation of customized information for the intended recipient of said e-mail, processor means for creating an e-mail containing or providing access to the contents of said sales or marketing information files, and computer communication means for sending said e-mail to said intended recipient.

### PRIOR U.S. APPLICATION

This Specification is based on U.S. Provisional Application Serial No. 60/373,625 filed on Apr. 18, 2002. The inventor claims the benefit of Title 35, Section 119 of the U.S. Code based on said provisional application.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office Patent file or records, but otherwise reserves all copyright rights whatsoever.

### BACKGROUND OF THE INVENTION

A. Technical Field

The present invention relates generally to methods and systems for creation and distribution of informational communications regarding products and services via computer networks. More specifically, the present invention is an Internet-based system and method for creating and distributing rich media marketing and sales materials via e-mail, permitting large volumes of communications to be prepared and delivered quickly, efficiently, securely and cost effectively with real-time tracking capability.

B. Background

Traditionally, marketing and sales materials have been distributed using manually-created and distributed direct mail. A substantial drawback of the direct mail approach has been the relatively significant cost and labor involved in distributing the communications, particularly if the communication is individualized or customized for each recipient.

More recently systems and methods have been developed for creation and distribution of marketing and sales materials electronically via computer networks such as the Internet to existing and potential customers or customers. The communications usually are in the form of generic ads or solicitations which merely present the product or service identically in every communication to every customer. There are also prior art systems which generate a letter or solicitation containing a selected set of products or service informational brochures or other materials. They merely list the product or products selected, and provide a brief non-individualized description or explanation of the product and perhaps sample prices or rates at various ages and amounts of coverage. Some include embedded links to websites where banner and other types of advertisements as well as other information about products or services is provided. The extent to which the communications take into account the particular circumstances and needs of the individual prospective customer, or provide individualized explanations necessary to make an informed purchasing decision about the highlighted products, or enough interest to make further inquiries which may lead to a sale, has been relatively limited.

These systems also are limited in their ability to process large volumes of customer communications quickly and efficiently. This is attributable in large part to their requirement for human involvement, the required level of interaction as a necessary part of their operation, the sophisticated nature of the products in many cases, and because of the relatively unsophisticated nature of the known systems and communications methods used. This necessitates substantial costs for wages, salaries, benefits, etc., and it can increase the likelihood of errors.

Users of such computer network systems typically rely on robust applications, such as web browsers and browser technology, to handle and maintain the transfer of information between systems. Existing applications to communicate with a user via the Internet are based on the following two methods:

1) Using an Internet browser (such as Netscape and Internet explorer, for example) that is installed and run on the user's computer to communicate with a server.

2). Having the user download and install a custom application on the user's computer hard drive to communicate with the server.

In method 1), the Internet browser holds specific objects (such as, for example, the history object of the browser itself, or a custom object supported by the browser) which can be recognized by the desired web server.

In method 2), the custom application installed on the user's computer is used to communicate with the server.

In settings where the intent of the user is to use the browser or application, there is little question given to the issue of engaged system resources or bandwidth usage, as both are fundamental components to the primary activity engaged in by the user. The current practice of launching an additional browser window or dedicated application to accommodate the new media, initiate the connection, or transfer the information requires much more computer resources than are actually needed.

Use of this methodology typically also addresses the need for security in electronic communications; a browser or other preexisting application is employed simply because of the preexisting security measures that are incorporated into browsers, as well as the long-standing abilities of browsers to effectively negotiate communications between systems. This practice has its drawbacks, for, while providing means for security, browser interaction also permits the automated exchange of information that is not secure.

Security measures themselves typically involve a number of complex elements, including (1) the generation, distribution and management of public and private encryption keys, and (2) establishing dedicated security systems and architecture for database systems used to store, provide, and manipulate the information deemed worthy of security protection.

Tracking of receipt and responses to marketing and sales materials is another feature that prior art systems have addressed in a relatively inefficient manner. Typically, tracking of Internet-based advertising and user responses to same is accomplished by redirecting a user's response. First, a connection is established with a tracking system that records the user's response to the URL of the selected ad or link, and then, the destination IP address URL is provided.

With prior art systems, customer and business computer resources are taxed in requiring the system to launch and maintain an additional application that may well exceed the necessary capabilities required for the desired communication and, in some cases, even the capabilities of the system itself. Additionally, as browsers and networked applications are continuously involved in two-way communication between the customer and server systems involved in the communications, the bandwidth resources available to the communication effort are monopolized at a level, that although customary, are perhaps more than truly required.

Recent efforts to address these drawbacks in prior art methods and systems for Internet communications include the use of File Server Direct Communication, or “FSDC.” FSDC is a method to establish a direct connection via the Internet between a self-contained file and a custom server-based application for online secured transactions, statistic tracking and server-based data sharing. FSDC uses a .swf file or alternately an html file, which can send a query string directly to the specific URL for a desired server without loading variables from the file (or html code) or requests to the history object of the Internet browser.

### SUMMARY OF THE INVENTION

The present invention provides a system and method for the creation and transfer of customized rich media sales and marketing information by a business, more particularly typically business sales personnel, for and to existing or potential customers or customers via the Internet in the form of e-mails. Businesses desiring to use the system of the present invention register with the system to obtain user identifications and passwords for its authorized sales personnel, who are typically the primary users of the system. Such businesses also provide their existing sales and marketing materials, such as television, print and streaming rich media electronic presentations and materials, to the system operator for conversion as necessary and storage for use later in creating customized sales and marketing materials for business customers. New materials can also be created specifically for use in customer e-mails created and sent using the system of the present invention. The system stores such materials in a database for selection and use by business sales personnel in creating customized information packages for customers.

The system also provides e-mail receipt and response tracking as well as sales force management tracking, providing sales force administrators with a novel system for monitoring the activities of its sales people, such as the number of e-mails created and sent in a specified period of time, ratios of responses to e-mails sent for each salesperson user of the system, the effectiveness of particular media files in producing sales results, as well as a searchable system for maintaining an up-to-date salesperson and corresponding customer list and a searchable library of sales media files. The tracking capability of the present system allows salesmen to identify and select media files for sales material e-mails that have historically proved most effective in similar situations.

The system and method of the present invention can be implemented using known methods of browser-based Internet communications and e-mail applications, or, in a preferred embodiment, using FSDC. FSDC as invented and used by the applicant is described and claimed in the applicant's pending U.S. non-provisional patent application entitled “Method and System For File Server Direct Connection,” application Ser. No. 10/316431 filed on Dec. 11, 2002, the Specification and Figures of which are incorporated herein by reference.

The system, in a preferred embodiment that utilizes FSDC, allows customers to receive and respond to such e-mailed marketing and sales materials by directly establishing network connections between the customer's computer and the server system where the electronic versions of the business' sales and marketing materials are stored by means of a single compiled file that does not require an additional network communications system such as a web browser or other supporting application. Specifically, by launching the e-mailed compiled file itself, a network connection is established to an encoded URL, and information is delivered to the customer in the form of streaming media. Differing from a typical browser, or other typical network enabling software systems, the communication link established by the compiled file is predominantly one way and non-conversational. Relying on graphical animation media, the system permits the delivery of new information and embedded code in response to a customer's action. Impact on system resources is reduced as overhead support software is not required. Likewise bandwidth is conserved and issues of privacy are maintained as minimal information is exchanged without user interaction.

By providing for TCP/IP communication over a network by means of a self-contained file that generates a non-conversational message directed to a server for storage and/or processing the amount of unintended information transferred from the customer's system to the server system, and access to the customer's system from the server system (which may be unknowingly provided) is minimized or eliminated. It also provides the means and capability to rapidly provide interaction between the customer and server systems by reducing the exchange of information to be as nearly one-way as possible, thus, conserving bandwidth resources and permitting greater speed in transfer and perceived interaction.

The present invention also provides the means and capability to transmit a secured message without requiring additional security system applications, protocols, or end user involvement. The system receives and maintains data in a secured form without requiring the distribution of encryption keys. The system database server does not require specific security integration or setup. Encryption keys are managed from a single location without requiring direct end user interaction. Bandwidth requirements for transfer are, reduced thereby increasing the relative speed of the communication transaction speed.

The system and method of the present invention are based on the idea that some specific objectives on the Internet do not require a conversation between a user's computer and a server but can be achieved and even work better if the communication is one way from the user's computer to the server.

In a preferred embodiment, the tracking functions of the present invention are performed in a more efficient manner than prior art systems. Instead of redirecting a user's request as discussed above, when a customer receives sales or marketing materials via e-mail using the present invention and in response clicks or requests a URL from the information provided, the customer is taken directly to the URL of interest, while a query string is independently sent to the system's tracking server from the destination file. The performance of the tracking server is not apparent to the customer and cannot affect the customer's use of the system. The tracking data is more accurate and can represent several different customizable parameters sent from the destination file viewed rather than merely counting the number of requests. Further, the use of independent connection processes insures that the customer's system and privacy is not further exposed to the tracking system.

Within the context of secured transactions, the present invention provides complete security by imposing encryption during the process of transmission and storage.

Within the context of server side data sharing, the present invention provides fast and efficient, predominantly one-way communication, without opening the user's system to the Internet.

### BRIEF DESCRIPTION OF THE DRAWINGS

FIG. 1 is diagrammatical overview of the Internet communication flow of the present invention.

FIG. 2 is a diagrammatical representation of system components and their interrelationship.

FIG. 3 shows how the query string in an e-mail sent to a customer with marketing or sales information using the present invention is sent to the system server as a one-way message.

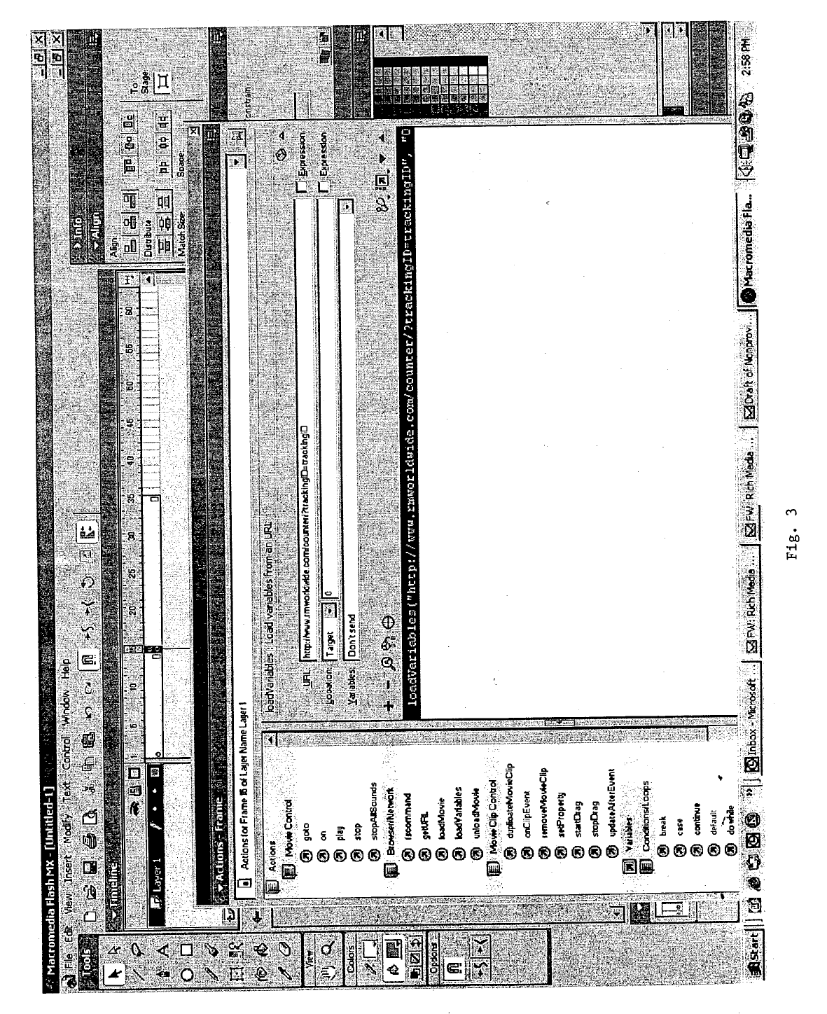

FIG. 4 depicts a sample new system user registration screen.

FIG. 5 depicts a sample system user login screen.

FIG. 6 depicts a sample system user options screen.

FIG. 7 depicts a sample customized sales and marketing information file selection screen.

FIG. 8 depicts a sample system user information and status screen.

FIG. 9-A depicts a sample system user basic e-mail tracking screen.

FIG. 9-B depicts a sample user e-mail tracking screen with additional customizable tracking features.

FIG. 10 depicts a sample system user e-mail creation screen.

FIG. 11 depicts a sample e-mail created by the system, as received by a customer.

FIG. 12 depicts a sample system user profile screen whereby salesperson system use activity is tracked and monitored, for sales personnel performance management.

### DESCRIPTION OF A PREFERRED EMBODIMENT OF THE INVENTION

According to a preferred embodiment hereof, the present invention is a method and system for use by business sales personnel to create and send to potential customers customized rich media marketing and sales materials via e-mail. The method of the present invention comprises the steps of: storing one or more sales and marketing materials pertaining to said business in electronic file format in one or more databases within a mass storage device of a computer system having an Internet communications server configured to host an Internet access software application for future selection and retrieval of said one or more sales and marketing materials in electronic file format by said business sales personnel, assigning to each said electronic file an identifier data string representing the contents of said data file, selecting one or more of said stored sales and marketing material files for delivery via e-mail to said potential customer, creating an e-mail addressed to said potential customer that provides to said customer access to said one or more sales and marketing material files, and sending said e-mail to said potential customer.

The e-mail created utilizing the method of the present invention can provide the sales and marketing material files to the business customer by various means, such as, without limitation, as a rich media file to which other files such as, for example, customized proposals, can be attached, or alternately as attachment to the e-mail, as a link to an Internet page wherein said materials are presented or, in a preferred embodiment, as a data string representing the contents of such sales or marketing material files with a URL attached to said data string, representing a custom server-based application to provide FSDC access to such materials upon opening of such e-mail by the customer.

In this preferred embodiment, the customer, upon receiving and opening such e-mail, can access and view the sales and marketing materials by FSDC without having to use a browser or access a website. The customer's opening of the e-mail itself can cause the custom server based application to execute and provide access to the desired information files, or alternately the e-mail can contain a link that when clicked by the customer causes the custom server-based application to execute and provide access to the desired information files. The customer's actions in opening the e-mail and/or clicking on the link provided is itself used as a tracking signal by the system.

In embodiments that use browser-based e-mail communications, known security features, typically those provided with the user's browser and system website applications, are utilized. Alternately, in a preferred embodiment, the method further comprises the steps of encrypting the first data string to form at least one encrypted data string for use in the e-mail transmittal to the customer, providing for the custom server-based application to decrypt such data string when the customer opens the e-mail to access the particular marketing and sales information file, such that the customer can access and view such files.

The system of the present investment in a preferred embodiment comprises: a system-end computer including an Internet communications server configured to host an Internet access software application program and including an Internet communications interface, a main processing unit and a mass storage device containing a one or more databases storing marketing and sales information files pertaining to said business, a business sales personnel-end computer configured for Internet access and communicating with said system Internet communications server, an e-mail recipient-end computer configured for Internet access and communicating with said system Internet communications server, interface means for said business sales personnel to select one or more sales and marketing information files from said one or more searchable databases for creation of customized sales and marketing materials for delivery via e-mail to said potential customer, processor means for creating an e-mail addressed to said potential customer providing access to said sales and marketing materials, and computer communication means for sending said e-mail to said potential customer.

The interface means, processor means and computer communications means can have various embodiments, including, without limitation, use of traditional Internet e-mail and browser applications, whether customized for use in the present system or existing third party software applications to provide the sales material files as an attachment to an e-mail in a format that the customer recipient can utilize, or by way of a link included in the e-mail that when clicked-on provides access to the sales material files located at the system end servers.

Alternately, in a preferred embodiment, the processor means creates an e-mail containing a data string representing the contents of the desired sales or marketing material files with a URL indicator attached to said data string, representing a custom server-based application to provide FSDC access to said files upon opening of said e-mail by the receiving customer. The customer recipient can, by simply opening an e-mail or clicking on an icon or link within the e-mail transmit such first data string and such URL indicator to the custom server-based application, and such transmittal may be made without opening the customer's computer to other locations or parties on the Internet. As noted previously, transmittal serves, at least in part, a purpose of tracking.

As noted previously, the system also provides e-mail receipt and response tracking as well as sales force management tracking, providing sales force administrators a novel system for monitoring the business e-mail creation, sending and related business production activities of its sales people, such as the number of e-mails created and sent in a specified period of time, ratio of responses to e-mails sent, effectiveness of particular media files in producing sales results, as well as a searchable system for maintaining an up-to-date salesman and corresponding customer list and a searchable library of sales media files. The tracking capability of the present system allows the business to manage its sales force and for salesmen to identify and select media files for use in sales material e-mails that have historically proved most effective in similar situations. Such capability can be provided via one or more system software applications.

The system, in a preferred embodiment, further comprises processor means for encrypting such data string to form an encrypted data string for use in the transmittal, computer communication means for providing for such custom server-based application to receive such transmittal, and processor means for providing for such custom server-based application, responsive to receiving such transmittal, to make at least one selected other data string and URL indicator available to the intended recipient/customer. The communication established between the networked systems (customer and server) is commenced entirely from the file created and provided under the present invention.

Use of the System

The users preferably contract with an Internet service provider for general Internet access and have a suitable Internet browser program on their computer system. Users of the system, such as, for example, sales people of a particular business, can log on to the system site by entering a password. Once the user's password is validated, access is granted to the system and its file server. The file server stores various rich streaming media files that users can select to create their own custom sales and marketing presentations in e-mail format for delivery to potential customers. As noted previously, the system preferably stores within the e-mail created by the system containing the custom sales and marketing materials the URL address for each of the media files selected, although other embodiments can use known means and methods for copying or attaching the files to the e-mail. When FSDC is utilized as in a preferred embodiment, the recipients of the e-mails view the materials including the rich media files by linking directly to the media files located at the system file server. Alternatively, the system server software and files could reside on the users' in-house server and could be accessed through their own internal network. In such embodiments, the system comprises a business sales personnel-end computer including an Internet communications interface, a main processing unit and a mass storage device containing one or more databases storing marketing and sales information files pertaining to said business, an e-mail recipient-end computer configured for Internet access and communicating with said Internet communications interface, interface means for said business sales personnel to select one or more sales and marketing information files from said one or more searchable databases for creation of customized sales and marketing materials for delivery via e-mail to said potential customer, processor means for creating an e-mail addressed to said potential customer providing access to said sales and marketing materials, and computer communication means for sending said e-mail to said potential customer.

The system database is structured to support direct marketing activity via the web-based mailing system. It allows sales personnel users to build custom e-mails with professional marketing content, using predefined and stored in the database custom elements (such as subject lines, text body, illustrations, rich media content, proposals and other marketing materials). Sales personnel users can send unlimited number of messages using a system-maintained “Address Book” and track customer recipients' activities with respect to the e-mails in real-time. At the same time system sales personnel administrators can monitor sales personnel users' activity in real-time including sales personnel performance and sales or marketing material effectiveness and manage sales team collaboration.

The database is stored in a large capacity mass storage device, such as a hard disk drive, or can alternatively be stored in a large capacity RAM or other alternative mass storage medium.

System Hardware

The system includes a customer and user-side personal computer systems configured for Internet access and communicating with the system server at the system end. The system end server is configured to host an Internet access application program and includes an Internet communication interface, a main processing unit and a mass storage device. A master database is stored in the mass storage device and contains the various rich media and other marketing and sales information files, which, as noted previously, can consist of electronic versions of the particular business's existing sales and marketing materials.

The system user interface, in a preferred embodiment is based on (a) SQL server (which, for example, can be Oracle or Microsoft Access) database; (b) web-based interface generated by active server pages (written, for example, in Visual Basic); (c) server based mailing system (for example, Dev Mailer or Microsoft SMTP); and (d) active server pages, Flash and XML-based applications to dynamically create email documents combining pre-built custom marketing content (elements) and to assign unique tracking codes to it.

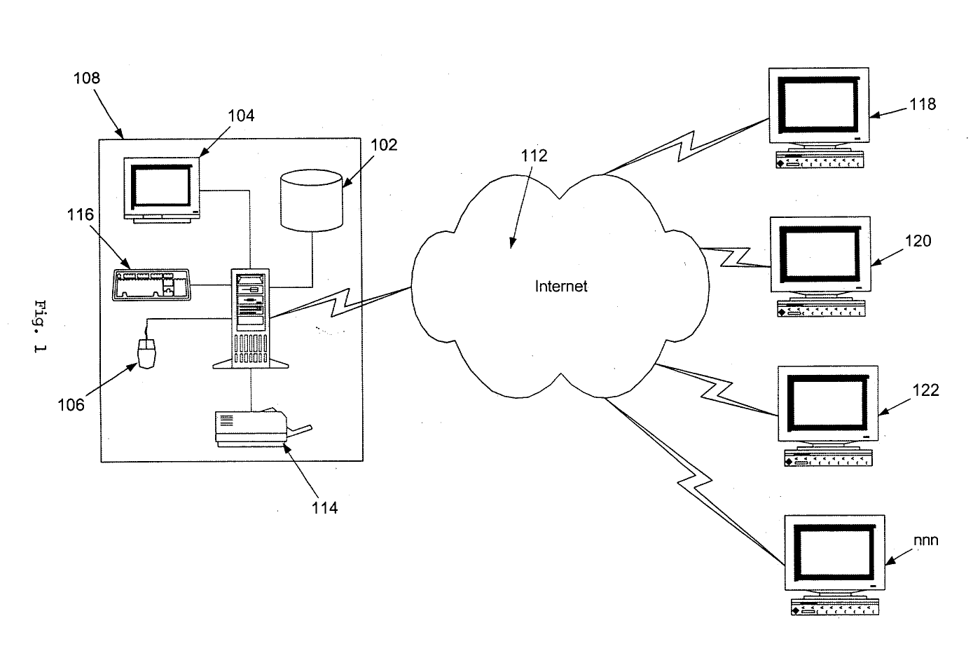

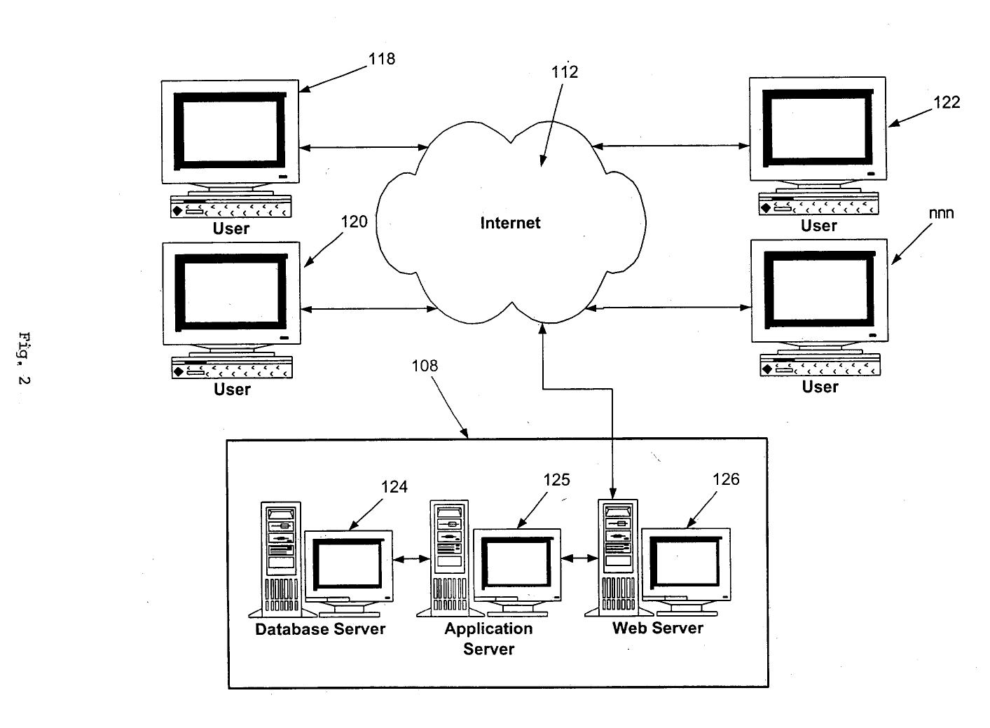

Referring now to FIGS. 1 and 2, an overview of a preferred embodiment of the present invention is shown. The present invention preferably comprises a computer system 108. The computer system 108 comprises input and output devices, as is well-known in the art. For example, the computer system 108 preferably comprises a display screen or monitor 104, a keyboard 116, a printer 114, a mouse 106, etc. The computer system 108 further preferably comprises a database 102 for storage of the data, and software comprising preferred embodiments of the present invention. The computer system 108 is preferably connected to the Internet 112 that serves as the presently preferred communications medium. The Internet 112, as previously discussed, comprises a global network of networks and computers, public and private. The Internet 112 is the preferable connection method by the users 118, 120, 122 and nnn in preferred embodiments of the present invention.

Referring now to FIG. 2, the computer system 108 is shown in more detail. The computer system 108, in a preferred embodiment, comprises a database server 124, an application server 125, and a web server 126. The database server 124 preferably runs in a variety of operating system environments, including MS Windows NT, MS Windows 2000, MS Windows XP, Linux and others, and preferably utilizes a variety of database management systems, including MS SQL Server, Oracle and others. The application server 125 preferably runs in a variety of operating system environments, including MS Windows NT, MS Windows 2000, MS Windows XP, Linux and others. The web server 126 also preferably runs in a variety of operating system environments, including MS Windows NT, MS Windows 2000, MS Windows XP, Linux and others. Preferably, the web server 126 operates only as the web server.

Connectivity between the customer-end portion and the network may be effected in various forms without violating the scope and spirit of the present invention. In particular, network connectivity may be made by a telephone line/modem combination as is well known in the art, a dedicated ISDN line or a cable modem-type set-top-box which provides for Internet connectivity through certain forms of cable television services. In each of the aforementioned cases, the computer of the user-end portion will need to be provided with a suitable I/O card, such as a modem, ISDN card, and the like, in order to effect an appropriate interface with the network connection.

In application, the system generates and delivers to the customer sales or marketing materials by means of e-mail, whether as a rich media file to which other files, such as, for example, customized proposals, can be attached, or as an embedded link to an ad or file in a web page or as a compiled file. Preferably, this compiled file is a Flash file identified by the .SWF suffix other html or other files can be used. The use of the Macromedia Flash file is preferred because of the ability to provide instructional code within the .SWF, and because nearly all customer computer systems have been enabled with the Flash player as a result of normal Internet browser configuration. It is to be understood that under the teachings of the present invention, any type of file that is capable of operation without the instantiation of an additional application could be used in place of Flash and the .SWF file and use of a .swf file is not a limitation of the present invention.

Under the present invention, the customer recipient of the e-mail activates the compiled file by placing the mouse cursor over the file or ad and double clicking the mouse. As enabled by the Flash player, the file launches as a self-contained window. As directed by its internal coding, the .SWF establishes a connection, via TCP/IP, with the specified server, and pulls Flash images for presentation to the customer.

The coding of the .SWF file establishes two substantially simultaneous connections, with one to the indicated server, for the purpose of fetching Flash images for presentation to the user, and the second communication link to the sales and marketing file, so that a tabulation may be made, appropriately noting the response to the e-mailed content. As the communications to both systems are only made once the file has been open, this is preferred over the prior art methodologies, which initiate the communication for tabulation prior to completing the link to the desired site. In many cases, such tabulation is premature, as the customer may close the window before the earlier desired material is delivered.

Various components of the Flash window are preferably enabled for user interaction. Such components may be text input boxes, option buttons, or other components. As each image that comprises the animated presentation must be delivered to the customer system, the server is provided with a means to track the time and length of the connection.

When the customer selects an enabled feature of the active Flash screen, the compiled program attaches a specific code element (which may be previously defined, or compiled with user supplied information) to a URL internally known to the file. This information is received by the server, and parsed from the end of the URL by means commonly known and understood by those skilled in the art of network and database interaction. Based upon the returned information as parsed, the server may modify or select a different image for delivery to the customer system. In other instances, the information returned may preferably simply be written to a database for use or tabulation at a later date.

System Screens

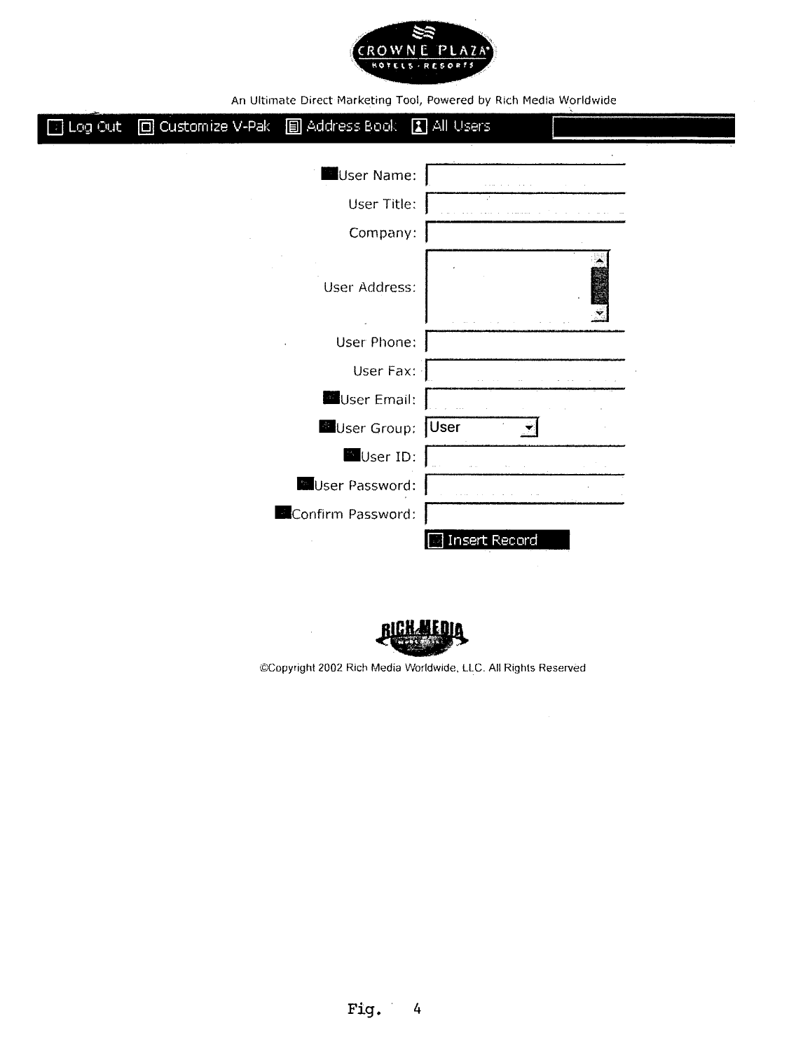

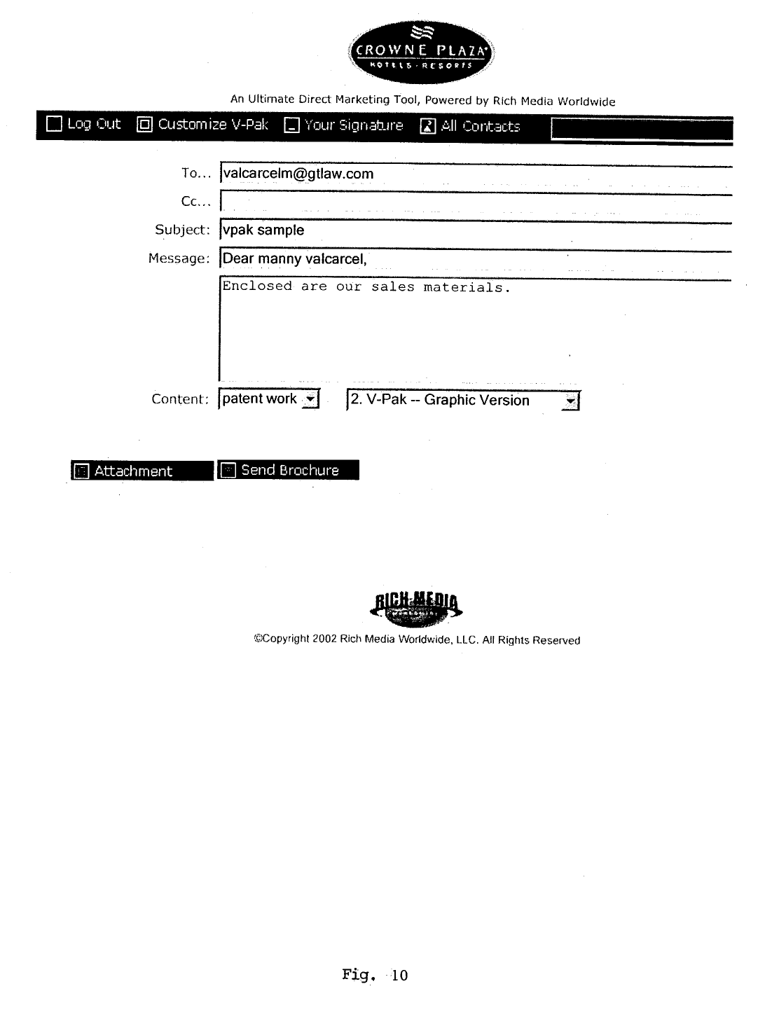

FIGS. 4-12 depict representative samples of the system's graphical user interface screens.

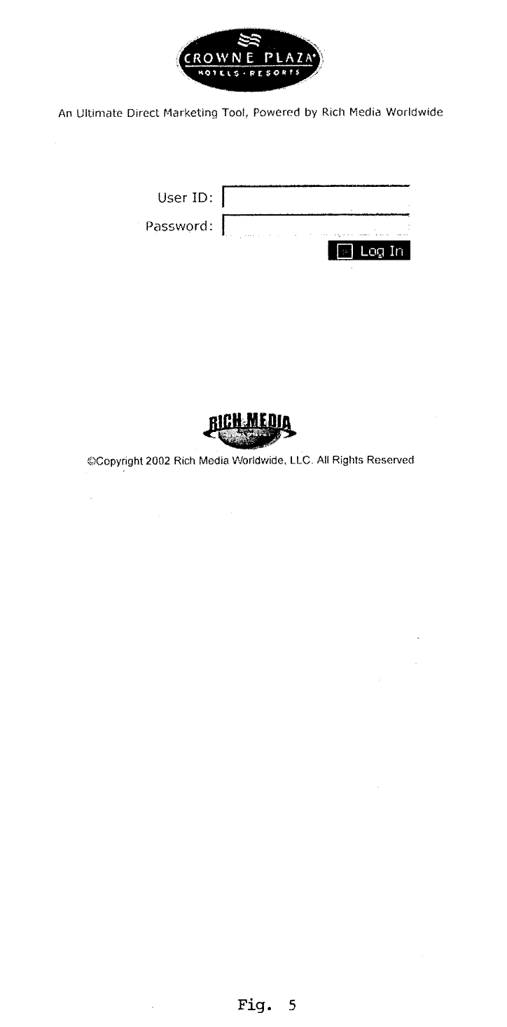

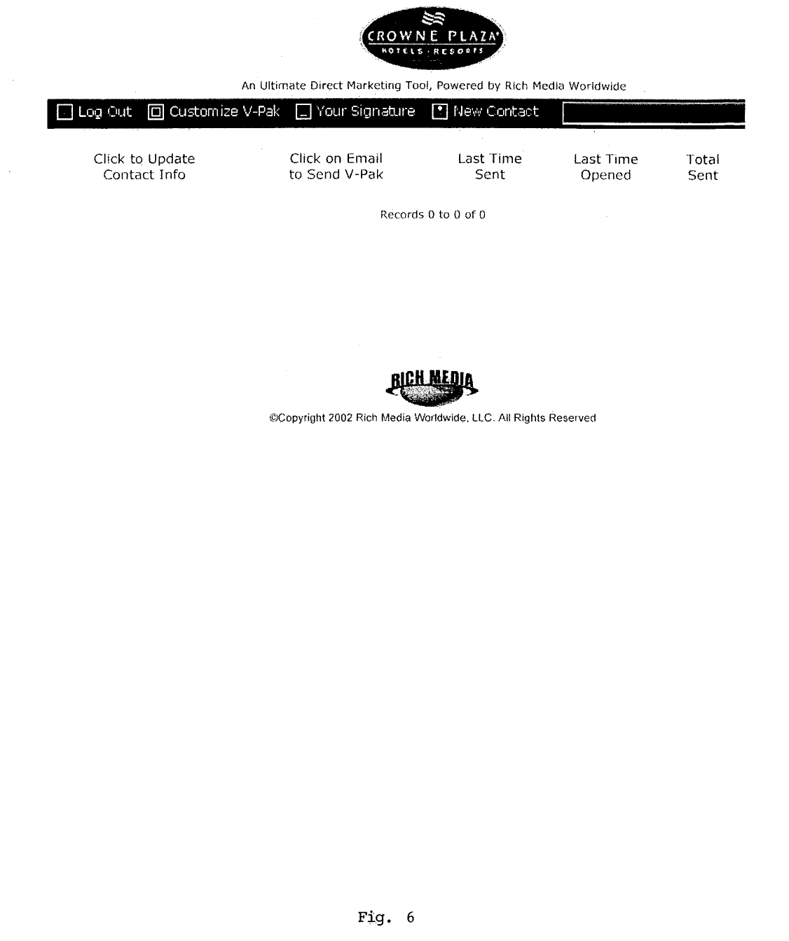

FIG. 5 depicts a sample user login screen. Users who are registered with the system enter their user identification and password to access the system. New users must register with the system by completing an online form as depicted in FIG. 4. Once logged in, users are presented with a screen such as FIG. 6, which has various options, including logout, create customized materials, customer contacts, send e-mail and tracking.

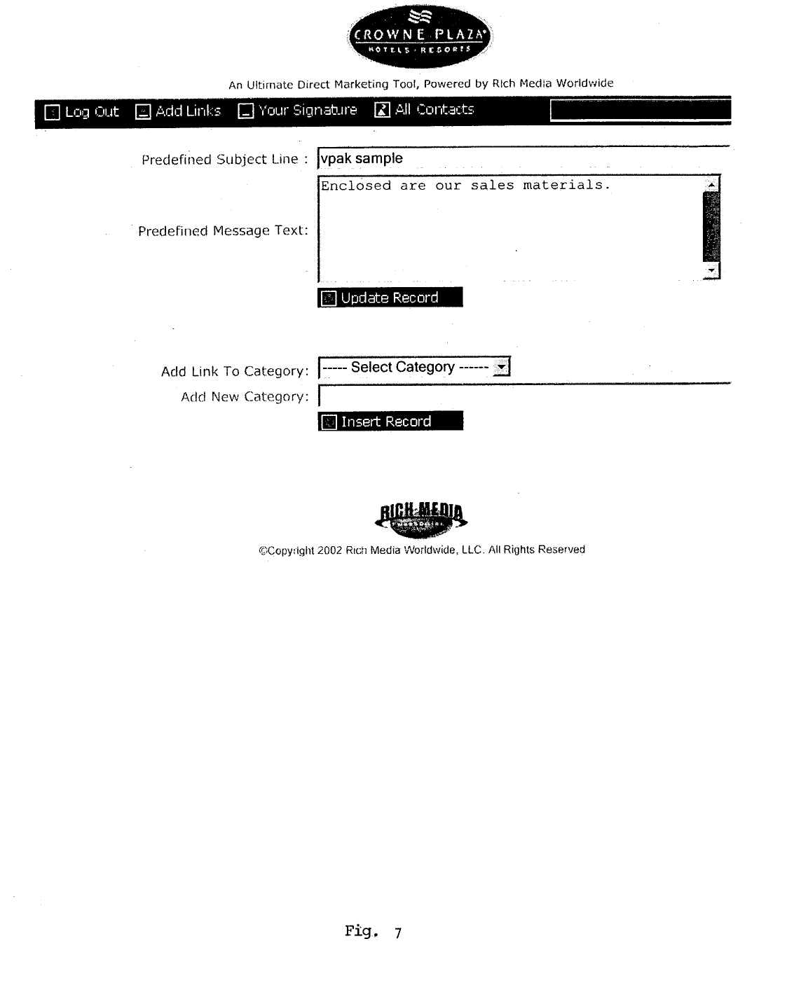

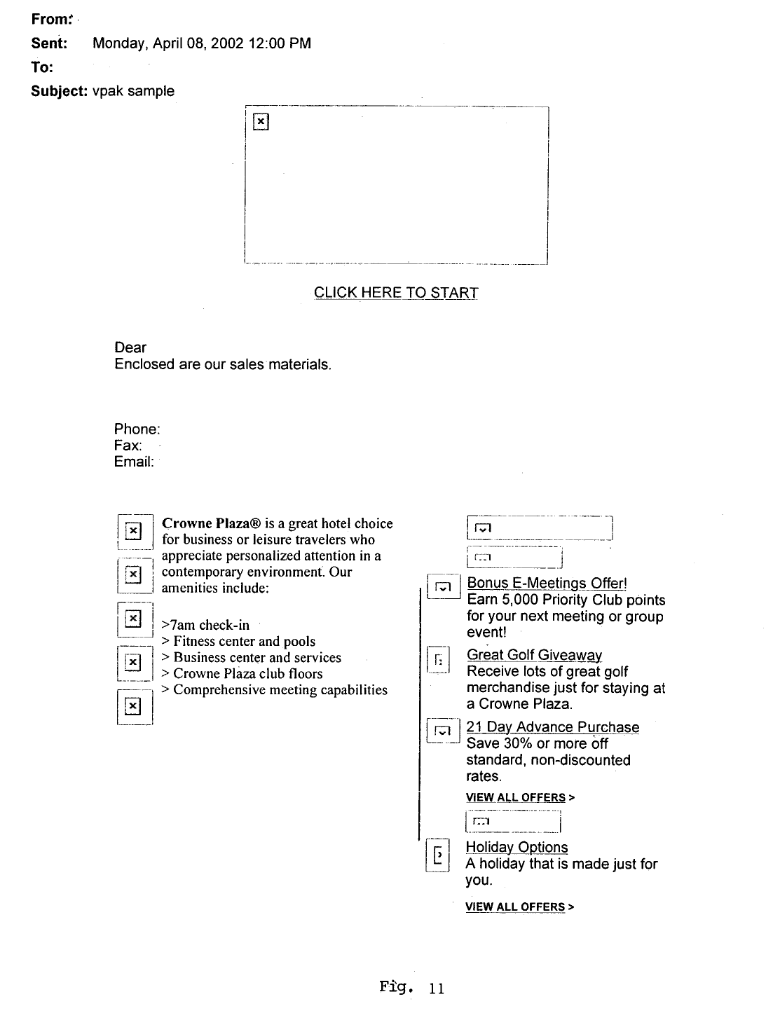

Referring to FIG. 7, which depicts a sales and marketing file selection screen, where users enter what they wish to appear on the subject, message and attachment portions of the e-mail to be sent. Categories of content files that are available for selection are provided through pull-down menus. Users can select files as needed to create customized sales and marketing materials. The stored files available for selection can be numerous such that e-mail presentations can be unique from one another, giving the recipient a specific, customized presentation that has been tailored to the specific recipient. When a user has finished preparing the e-mail, the user clicks “send” and the e-mail is sent to the intended customer, as depicted on the screen shown in FIG. 11.

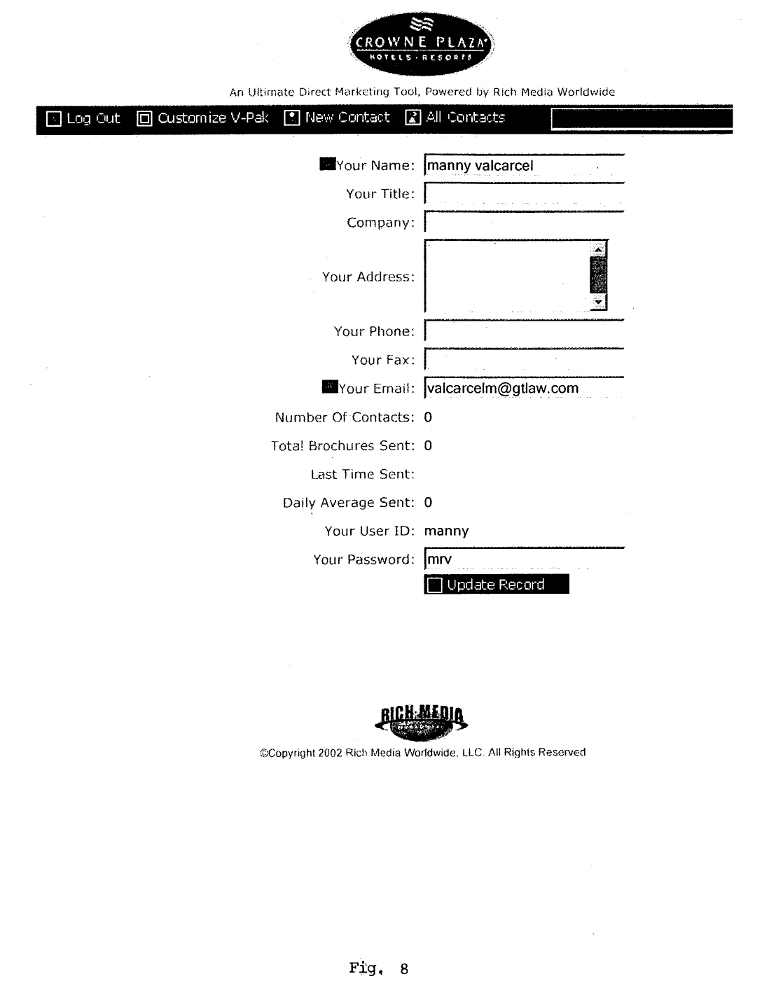

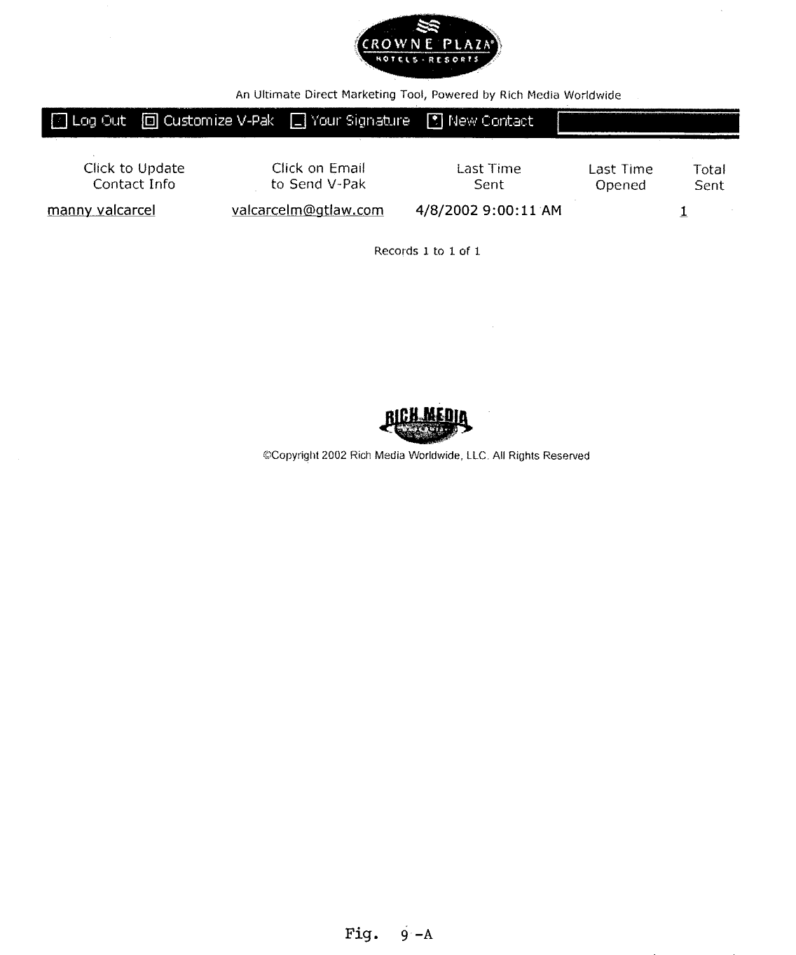

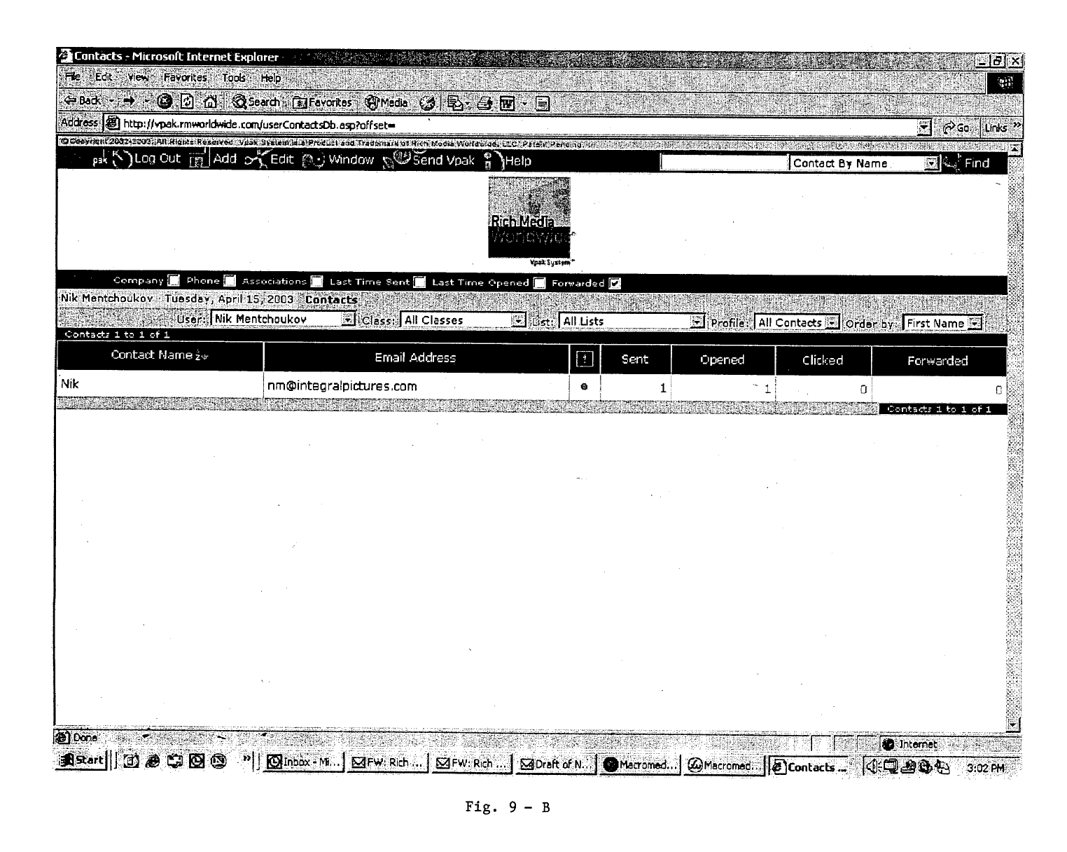

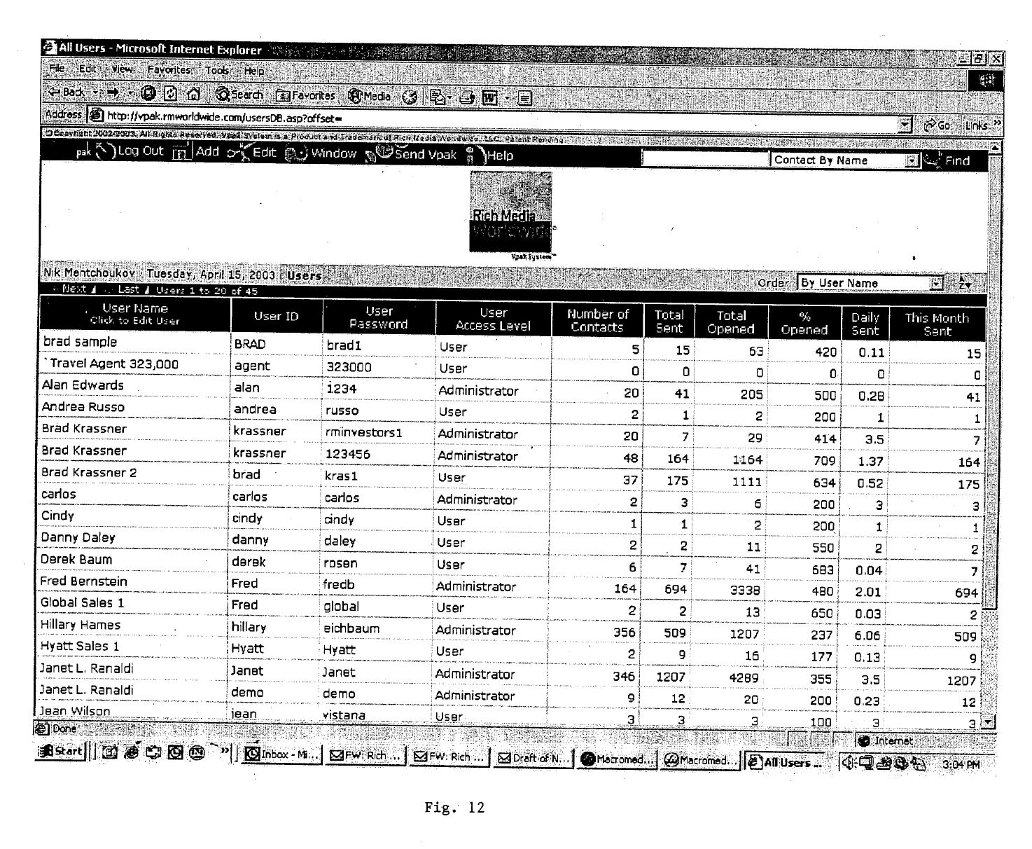

Referring now to FIG. 8, sales personnel users and their administrators can track sales personnel use of the system. The user information screen shown in FIG. 8 provides information to users regarding the number of customer contacts whose information is in the system, the number of e-mails sent, the last time one was sent, daily averages of e-mails sent and other relevant and useful information. FIG. 9 depicts a sample customer e-mail tracking screen, which provides information regarding the sending, delivery and opening of the e-mails sent through the system. A sample of an e-mail produced through the system is depicted in FIG. 11. FIG. 12 depicts a sample sales personnel user system usage activity tracking screen whereby salesperson system use activity can be tracked and monitored, so that business management can monitor the performance of its sales personnel. Among other data that can be monitored is sales personnel user access data, the number of e-mails sent to customers on a daily, monthly or other basis the number of e-mails opened by customers and the number of opened e-mails resulting in further business contact with the recipient customers.

1) Tracking

As noted previously, tracking functions can be performed using existing tracking methods, (by Double Click, for example) which are based on the idea of re-directing the user's request. With this method when the user clicks on an ad file with an imbedded URL the request first goes to a specific URL which contains a special script or application which calculates these requests and then after executing this sends the user to the requested destination. This method slows down the user's experience and Internet performance because the user is connected to the tracking server first, then from the tracking server to the destination server, and the performance of the tracking server becomes an issue.

In a preferred embodiment of the present invention, these actions are split and independent from each other. When the user clicks or requests a URL from the system, the user directly accesses the requested URL while a query string is independently sent to the tracking server. The performance of the tracking server cannot affect the user's experience, and reliability is increased because the execution of these two actions is not dependent on each other. This query string, or its result, can contain or generate all the necessary information for statistical calculation, including time of action, IP address of the user and does not require any communication back from the server to the user, which can compromise the user's privacy. A non-conversational message can be sent right from HTML part of email body or web page at the moment when this page is loaded in email interface or web browser. A standard HTML tag is used, which holds images in the document body <img src=″″>. Instead of using the URL for the image, the system uses the URL for the Active Server Page, which recognizes URL parameters as a tracking string and executes storing and executes storing received data in database. A sample string is as follows: <img src=‘http://www.richmediaclub.com/counter/coCpInBody.asp?messageID=“ & messageID & ”’ width=‘1’ height=‘1’> (where ‘messageID’ is dynamically assigned tracking variable).

Below is an example of the type of code that preferably would exist on the server, and which would process the received string of information attached to the URL. The sample code below (which in our case is getMessage.asp file), grabs the query string received and stores it in the database for tracking purposes:

<%@LANGUAGE=“VBSCRIPT”%>
<%
′UID = Request.QueryString(“Id”)
UID = Request.QueryString
if UID = “” then UID = “Anonymous”
if len(UID) > 100 then UID = “TooLongUID”
for i = 1 to len(UID)
p = right(left(UID, i),1)
if p = Chr(34) or p = Chr(39) then tmp = tmp & p
end if
next
′replace UID, chr(34), “”
′replace UID, chr(39), “”
UID = tmp
Set cn = Server.CreateObject(“ADODB.Connection”)
cn.Open “FILEDSN=userData.dsn”
Set rsCount = Server.CreateObject(“ADODB.Recordset”)
Set rsVisitors = Server.CreateObject(“ADODB.Recordset”)
rsVisitors.Open “SELECT*FROM visitors WHERE UID=“& UID &”, cn
if rsVisitors.EOF then
cn.Execute(“INSERT INTO visitors (UID, LastDate, LastTime,
VisitCount)
VALUES (“& UID &”, “& date &”, “& time &”, 1)”)
else
rsCount.Open “SELECT VisitCount FROM visitors WHERE UID=“&
UID &”,
cn
cnt = rsCount.Fields.Item(“VisitCount”)
cn.Execute(“UPDATE visitors SET VisitCount = 1+“& ent &”,
LastDate = “& date &”, LastTime = “& time &”WHERE UID = “&
UID &””)
end if
%>

Multiple tracking data can be obtained as the customer recipient continues to click on additional sales presentation files provided via the e-mail. The system permits the sales personnel system users to send and track multiple e-mails at one time on a real-time basis, as the recipients work through the e-mail presentations. This tracking functionality can be used to test and/or educate customers through e-mailed informational presentations in the form of lessons.

2) Secured Transactions

Security can be provided using existing secured transaction methods (by Verisign, for example), which are based on the communication between a web server and an Internet Browser on the user's side. With a special file/key generated by Verisign the secured data is encrypted on the user side and instantly unencrypted on the server side. This method inevitably slows down the performance of the transaction and at the same time cannot guarantee the total security of the user's information.

A preferred embodiment of the present invention produces complete security for two reasons: 1) unencryption does not occur during the transaction; and 2) communication does not open the user's computer to the Internet. The system generates a specific template exported to the .swt format. .SWF is a file suffix identifying a Flash file. The .swf format is the final compiled form produced by a system or tool capable of generating macromedia Flash files. The .swf files may be created from scratch and edited as .fls, or from template files identified as .swt files, neither of which is intended for open distribution, as they are not compiled. This .swt file generates a specific custom formula for the encryption and unencryption of the data. Using off-line generating process, using Macromedia Generator in a preferred embodiment, and a server-side application two separate .swf files are generated and stored on the server. The first file is saved in a folder open to the public, which contains only the part of the formula which encrypts the data. The second file, the key file, contains the formula which is required to unencrypt the data, which is saved in a location closed to the public or on a disc on a local computer. The system also generates a formula for unencryption and a specific PIN, is be known only by the administrator. Therefore, even if the key file is stolen the formula cannot be activated without entering the PIN.

Below is an example of code that might be used to encrypt the contents of a one-way message before it is sent. As shown, such encryption may be as simple as variable and string substitution. It is to be understood that the methodology of encryption is not strictly limited to a type or form as that depicted, rather, under the present invention, users of the system may implement whatever form of encryption technique best suits their purposes. What is specific to the present invention is that the method of encryption is preferably provided to the user as part of the file they access, thus, there is no need for the user to have, acquire, maintain, or otherwise provide an encryption means on his or her own behalf. Further, under appropriate circumstances, the encryption keys used may be modified in each message that is sent to a user, such that security is heightened, and tracking the distribution of the message or ad file further enhanced. This shows a sample action script which can be attached to a frame or button of a Flash file, which takes the characters in the text field and converts each character in a sub-string of a query string to be send to a server:

if(pas.charAt(0)==1) {
firstChar = “046728763”;
} else if (pas.charAt(0)==2) {
firstChar = “87290987”;
} else if(pas.charAt(0)==3) {
firstChar = “34089274”;
}
if(pas.charAt(1)==1) {
thirdChar = “ad87f6adf76”;
} else if(pas.charAt(1)==2) {
thirdChar = “mwenbr53sd”;
} else if(pas.charAt(1)==3) {
thirdChar = “234hgjshd7643”;
}
if(pas.charAt(2)==1) {
secondChar = “nbvqwev672”;
} else if(pas.charAt(2)==2) {
secondChar = “823764ggd”;
} else if (pas.charAt(2)==3) {
seeondChar = “asdh28373ghssdfs3”;
}
encryptedString = firstChar+secondChar+thirdChar;
en = encryptedString;

// so the “load variable” string will look like

http://website.com/getMessage.asp?en = encryptedString.

This method allows creating an unlimited amount of bits and formulas in the encryption process as well as an unlimited amount of additional secured ideas of PINs and password. For example, multiple PINS known by multiple different administrators could be created, and all would be necessary to unencrypt the data.

The system offers the ability to encrypt the data in the user's computer without a browser, or even without an application, even from within an email body. The file grabs a string from the text field of the form, encrypts it using the specific formula made earlier and puts all the data into a one line query string. This query string will be sent to a custom server side application which can be written in any language which understands query strings (such as, for example, visual basic, c++, java, PHP, cgi) and saved on the server in its encrypted format. Unlike convention methods which immediately unencrypt data and save that unencrypted data on the server, the data saved on the system server remains encrypted and is useless to anyone who steals it.

In order to unencrypt the data, the encrypted file has to be opened with the previously generated key. For credit card processing this key can be stored in the processing bank, or on a local computer, so the data unencrypts only after the administrator accesses it.

3) Server Side Data Sharing

With conventional methods data sharing on the Internet involves a two-way communication between one or multiple users and a server. As described earlier, this two-way communication opens the customer's computer to the public and slows down the performance of the data sharing. In a preferred embodiment of the present invention, a user sends his data one way to the server. The data is then generated to an .swf file which can be grabbed by another user from the Internet, adjusted, then sent back to the server to be generated and gabbed again. This method of data transfer is safer and faster, and works well with any application where data sharing is necessary, such as distance learning, games, banking, etc.

The system and method of the present invention can be utilized by various types of businesses with a need to prepare and send marketing and sales materials to existing or potential customers. In fact, the system can be utilized to provide a uniform, quick and easy to manage way for a potential buyer of products or services to review the business and sales presentations of multiple vendors, such as in a request for proposed/bid submission situation. All bidders could create and submit their bids using the present invention. The system is easily integrated to include electronic commerce functionality permitting the e-mail recipients to proceed with purchase or other transactions.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. A method for business sales personnel to create and send customized rich media marketing and sales materials via e-mail to potential customers, and for said business to monitor and manage sales force activity comprising the following steps:
storing one or more sales and marketing materials pertaining to said business in electronic file format in one or more databases within a mass storage device of a computer system having an Internet communications server configured to host an Internet access software application for future selection and retrieval of said one or more sales and marketing materials in electronic file format by said business sales personnel,
assigning to each said electronic file an identifier data string representing the contents of said data file,
selecting one or more of said stored sales and marketing material files for delivery via e-mail to said potential customer,
creating an e-mail addressed to said potential customer that provides to said customer access to said one or more sales and marketing material files, and
sending said e-mail to said potential customer.

2. The method of claim 1, further comprising the step of tracking said potential customer's activity with respect to said e-mail by causing a data string to be sent to a tracking server each time that said potential customer accesses one or more of said sales and marketing materials.

3. The method of claim 1, wherein said e-mail provides said sales and marketing material files as one or more rich media files embedded in said e-mail.

4. The method of claim 1, wherein said e-mail provides said sales and marketing materials as an attachment to said e-mail.

5. The method of claim 1, wherein said e-mail provides said sales and marketing materials via a link to an Internet page wherein said materials are presented.

6. The method of claim 1, wherein said e-mail provides said sales and marketing materials via a data string representing the contents of said sales and marketing materials with a uniform resource locator forming part of said data string representing a custom server-based application that executes to provide file server direct connection access to said materials upon opening of said e-mail by said potential customer.

7. The method of claim 6, further comprising the steps of
encrypting said data string to form at least one encrypted data string for use in said e-mail, and
causing said custom server-based application to decrypt said data string when said potential customer opens said e-mail to access said marketing and sales materials.

8. The method of claim 1, further comprising the step of tracking business sales personnel e-mail creation, sending and business production activity with respect to said e-mail.

9. A system for use by business sales personnel to create and send to potential customers customized rich media marketing and sales materials via e-mail, comprising:
a system-end computer including an Internet communications server configured to host an Internet access software application program and including an Internet communications interface, a main processing unit and a mass storage device containing a one or more databases storing marketing and sales information files pertaining to said business,
a business sales personnel-end computer configured for Internet access and communicating with said system Internet communications server,
an e-mail recipient-end computer configured for Internet access and communicating with said system Internet communications server,
interface means for said business sales personnel to select one or more sales and marketing information files from said one or more searchable databases for creation of customized sales and marketing materials for delivery via e-mail to said potential customer,
processor means for creating an e-mail addressed to said potential customer providing access to said sales and marketing materials, and
computer communication means for sending said e-mail to said potential customer.

10. The system of claim 9, wherein said processor means creates an e-mail containing a data string representing the contents of said sales and marketing material files with a uniform resource locator attached to said data string, representing a custom server-based application to provide to said potential customer file server direct connection access to said files upon opening of said e-mail.

11. The system of claim 10, further comprising
processor means for encrypting said data string to form an encrypted data string for use in the e-mail sent to said potential customer,
computer communication means for said custom server-based application to receive said transmittal, and
processor means for said custom server-based application, responsive to receiving such transmittal, to make at least one selected other data string and uniform resource locator available to said potential customer.

12. The system of claim 9, further comprising means for tracking of said potential customer's activity with respect to said e-mail.

13. The system of claim 9, further comprising means for tracking business sales personnel e-mail creation, sending and related business production activity with respect to said e-mail.

14. The system of claim 9, further comprising means for sales personnel management.

15. A system for use by business sales personnel to create and send to potential customers customized rich media marketing and sales materials via e-mail, comprising:
a business sales personnel-end computer including an Internet communications interface, a main processing unit and a mass storage device containing one or more databases storing marketing and sales information files pertaining to said business,
an e-mail recipient-end computer configured for Internet access and communicating with said Internet communications interface,
interface means for said business sales personnel to select one or more sales and marketing information files from said one or more searchable databases for creation of customized sales and marketing materials for delivery via e-mail to said potential customer,
processor means for creating an e-mail addressed to said potential customer providing access to said sales and marketing materials, and
computer communication means for sending said e-mail to said potential customer.

16. The system of claim 15, wherein said processor means creates an e-mail containing a data string representing the contents of said sales and marketing material files with a uniform resource locator attached to said data string, representing a custom server-based application to provide to said potential customer file server direct connection access to said files upon opening of said e-mail.

17. The system of claim 16, further comprising processor means for encrypting said data string to form an encrypted data string for use in the e-mail sent to said potential customer,
computer communication means for said custom server-based application to receive said transmittal, and
processor means for said custom server-based application, responsive to receiving such transmittal, to make at least one selected other data string and uniform resource locator available to said potential customer.

18. The system of claim 15, further comprising means for tracking of said potential customer's activity with respect to said e-mail.

19. The system of claim 15, further comprising means for tracking business sales personnel e-mail creation, sending and related business production activity with respect to said e-mail.

20. The system of claim 15, further comprising means for sales personnel management.
